(19) United States
(12) Patent Application Publication
(10) Pub. No.: US 2025/0141036 A1
(43) Pub. Date: May 1, 2025

(54) BATTERY HOUSING

(71) Applicants: Hyundai Motor Company, Seoul (KR); Kia Corporation, Seoul (KR)

(72) Inventors: Seok Eun Yoon, Hwaseong-si (KR); Young Hoo Oh, Hwaseong-si (KR); Yu Ri Oh, Hwaseong-si (KR); In Gook Son, Hwaseong-si (KR)

(21) Appl. No.: 18/922,612

(22) Filed: Oct. 22, 2024

(30) Foreign Application Priority Data
Oct. 30, 2023 (KR) 10-2023-0146983

(51) Int. Cl. H01M 50/358; B60L 50/64; H01M 50/209; H01M 50/271

(52) U.S. Cl. CPC H01M 50/358; H01M 50/209; H01M 50/271; B60L 50/64; H01M 2220/20

(57) ABSTRACT

An embodiment battery housing including a base plate configured to support a battery module and a side member extending along a periphery of the base plate to define a receiving space in which the battery module is accommodated, wherein the side member has a guide passage defined therein to guide a fluid generated from the battery module to outside of the receiving space.

### CROSS-REFERENCE TO RELATED APPLICATIONS

This application claims the benefit of Korean Patent Application No. 10-2023-0146983, filed on Oct. 30, 2023, which application is hereby incorporated herein by reference.

### TECHNICAL FIELD

The present disclosure relates to a battery housing.

### BACKGROUND

In recent years, research and development on electric vehicles, which are environmentally friendly vehicles, has been emphasized as crisis awareness of environments and oil resource depletion has increased. The electric vehicles include a plug-in hybrid electric vehicle (PHEV), a battery electric vehicle (BEV), a fuel cell electric vehicle (FCEV), and the like.

An electric vehicle may include a battery module and a battery housing supporting the battery module. Meanwhile, the electric vehicle uses battery cells of the battery module as a power source, and when a fire occurs in the battery module, there is a risk of thermal runaway.

Accordingly, there is a need for an electric vehicle capable of reducing heat transfer between battery modules that causes thermal runaway when a fire occurs in a battery module of the electric vehicle.

### SUMMARY

Embodiments of the present disclosure can solve problems occurring in the prior art while advantages achieved by the prior art are maintained intact.

An embodiment of the present disclosure provides a battery housing for guiding a fluid generated from a battery module to the outside of the battery housing.

The technical problems solvable by embodiments of the present disclosure are not limited to the aforementioned problems, and any other technical problems not mentioned herein will be clearly understood from the following description by those skilled in the art to which the present disclosure pertains.

According to an embodiment of the present disclosure, a battery housing includes a base plate that supports a battery module and a side member that extends along a periphery of the base plate to define a receiving space in which the battery module is accommodated, and the side member has a guide passage defined therein to guide a fluid generated from the battery module to the outside of the receiving space.

The side member may include a guide wall that faces the battery module and a cover wall spaced apart from the guide wall to define the guide passage between the guide wall and the cover wall.

The guide wall may include a guide hole connected to the guide passage.

The battery house may further include a mesh member disposed in the guide hole.

The guide wall may include a plurality of guide holes, and the guide holes may be spaced apart from one another in a front/rear direction of the battery module.

The guide wall may be spaced apart from the battery module in a first direction.

The side member may be disposed on a first side of the battery module in a first direction and may extend in a second direction perpendicular to the first direction, and the battery housing may further comprise an end member that is disposed on a second side of the battery module in the second direction and is connected to the side member and that defines a discharge passage connected to the guide passage.

The battery housing may further include an opening/closing part disposed in the end member to define a discharge hole through which the fluid flowing through the discharge passage is discharged.

The opening/closing part may include a cover grill mounted in the end member and a discharge plate that is disposed inward of the cover grill and that defines the discharge hole by pressure of the fluid flowing through the guide passage.

According to an embodiment of the present disclosure, a battery housing includes a base plate configured to support a battery module and a side member extending along a periphery of the base plate to define a receiving space in which the battery module is accommodated. The side member includes a guide passage defined therein to guide a fluid generated from the battery module to outside of the receiving space, a cover part including a guide wall and a cover wall, wherein The guide wall faces the receiving space and the cover wall is spaced apart from the guide wall to define the guide passage between the guide wall and the cover wall, a support part protruding from the cover part toward an outside of the base plate and a support rib extending from the support part to the cover part in an upward direction with respect to a direction toward an inside of the base plate.

The cover part may include an upper inner wall that connects the guide wall and the cover wall and that is disposed on an upper side of the guide passage and a lower inner wall spaced downward from the upper inner wall and disposed on a lower side of the guide passage.

A first end of the support rib may be connected to the support part and a second end of the support rib, opposite the first end, may be connected between the upper inner wall and the lower inner wall.

The support part may include an upper support wall connected to the support rib, a lower support wall disposed under the upper support wall, and a first vertical inner wall that extends in an up/down direction between a first end connected to the support rib and a second, opposite end connected to the lower support wall.

The support part may further include a vertical outer wall that connects the upper support wall and the lower support wall and a second vertical inner wall that is disposed between the first vertical inner wall and the vertical outer wall and that extends in the up/down direction between the upper support wall and the lower support wall.

The support part may further include a first horizontal inner wall that connects the first vertical inner wall and the cover wall and a second horizontal inner wall that connects the second vertical inner wall and the vertical outer wall.

According to an embodiment of the present disclosure, a battery pack system includes a battery module, an upper cover covering an upper surface of the battery module and a battery housing covering a lower surface and lateral surfaces of the battery module. The battery housing includes a base plate covering the lower surface of the battery module and configured to support the battery module and a front end member disposed at a front of the base plate a rear end member disposed at a rear of the base plate and side members disposed on opposite sides of the base plate and extending along a periphery of opposite sides of the base plate to define a receiving space in which the battery module is accommodated. Each of the side members has a guide passage defined therein to guide a fluid generated from the battery module to outside of the receiving space.

Each of the side members may include a guide wall facing the receiving space and a cover wall spaced apart from the guide wall to define the guide passage between the guide wall and the cover wall.

The guide wall may include a guide hole connected to the guide passage.

The battery pack system may further include a mesh member disposed in the guide hole.

The guide wall may include a plurality of guide holes, and the guide holes may be spaced apart from one another in a front/rear direction of the battery module.

The guide hole may include a plurality of guide holes, and the plurality of guide holes may be spaced apart from one another in a front/rear direction of the battery module.

A mesh member may be provided in the guide hole.

### BRIEF DESCRIPTION OF THE DRAWINGS

The above and other objects, features, and advantages of embodiments of the present disclosure will be more apparent from the following detailed description taken in conjunction with the accompanying drawings, in which:

FIG. 1 is a perspective view of a battery pack system according to an embodiment of the present disclosure;

FIG. 2 is a plan view in which an upper cover of the battery pack system according to an embodiment of the present disclosure is omitted;

FIG. 3 is an exploded perspective view of the battery pack system according to an embodiment of the present disclosure;

FIG. 4 is a perspective view of a battery housing according to an embodiment of the present disclosure;

FIG. 5 is a cutaway perspective view of the battery housing illustrated in FIG. 4;

FIG. 6 is a sectional view of the battery housing according to an embodiment of the present disclosure;

FIG. 7 is an enlarged view of portion A illustrated in FIG. 6;

FIG. 8 is a schematic view illustrating a state in which a fluid generated from a battery module is guided to the outside of the battery housing according to an embodiment of the present disclosure;

FIG. 9 is an enlarged perspective view of a first opening/closing part according to an embodiment of the present disclosure;

FIG. 10 is a sectional view of the first opening/closing part illustrated in FIG. 9; and

FIG. 11 is a cutaway perspective view of a battery housing according to another embodiment of the present disclosure.

### DETAILED DESCRIPTION OF ILLUSTRATIVE EMBODIMENTS

Hereinafter, some embodiments of the present disclosure will be described in detail with reference to the exemplary drawings. In adding the reference numerals to the components of each drawing, it should be noted that the identical or equivalent component is designated by the identical numeral even when it is displayed on other drawings. Further, in describing the embodiments of the present disclosure, a detailed description of well-known features or functions will be omitted in order not to unnecessarily obscure the gist of the present disclosure.

In describing the components of the embodiments according to the present disclosure, terms such as first, second, “A”, “B”, (a), (b), and the like may be used. These terms are merely intended to distinguish one component from another component, and the terms do not limit the nature, sequence, or order of the components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and they are not to be interpreted as having ideal or excessively formal meanings unless clearly defined as having such in the present application.

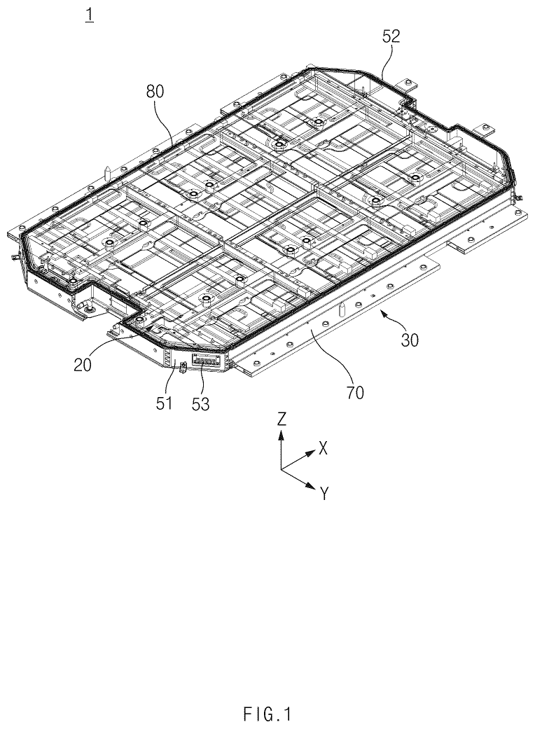

Hereinafter, embodiments of the present disclosure will be described in detail with reference to FIGS. 1 to 11.

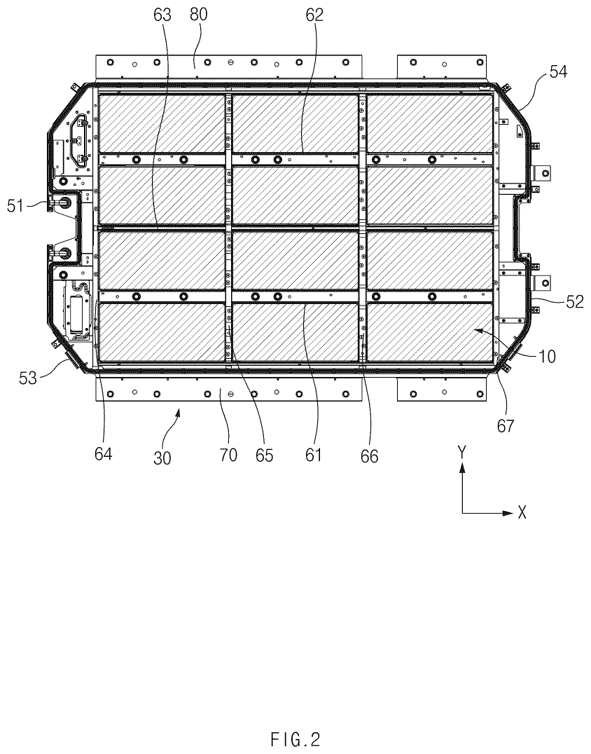

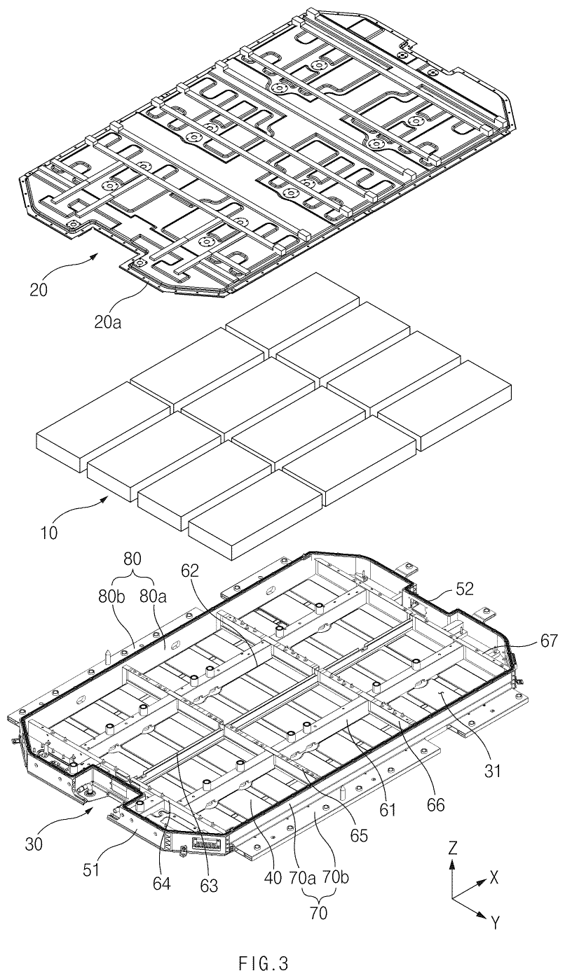

FIG. 1 is a perspective view of a battery pack system 1 according to an embodiment of the present disclosure. FIG. 2 is a plan view in which an upper cover 20 of the battery pack system 1 according to an embodiment of the present disclosure is omitted. FIG. 3 is an exploded perspective view of the battery pack system 1 according to an embodiment of the present disclosure.

Referring to FIGS. 1 to 3, the battery pack system 1 may be understood as a component mounted in an electric vehicle. The battery pack system 1 may include battery modules 10 used as a power source of the electric vehicle, the upper cover 20 that covers the upper sides of the battery modules 10, and a battery housing 30 that covers the lower sides and the lateral sides of the battery modules 10.

Each of the battery modules 10 may include a plurality of battery cells. The battery cells may be implemented with lithium ion batteries, but they are not limited thereto. The plurality of battery cells may be used in the form of the battery module 10 so as to be protected from impact, heat, and vibration from the outside.

The upper cover 20 may be disposed on the upper sides of the battery modules 10 and may cover the upper sides of the battery modules 10. The upper cover 20 may be coupled with the battery housing 30. The upper cover 20 may be coupled with the battery housing 30 through a peripheral portion 20a.

The battery housing 30 may include a base plate 40 provided to cover the lower sides of the battery modules 10 and may support the battery modules 10 and end members 51 and 52 including a front end member 51 disposed at the front of the base plate 40 (in the −X direction) and a rear end member 52 disposed at the rear of the base plate 40 (in the X direction).

The battery housing 30 may include side members 70 and 80 that are disposed on opposite sides of the battery modules 10 and that cover the opposite sides of the battery modules 10. The side members 70 and 80 may extend in the lengthwise direction of the base plate 40 and may be connected to the front end member 51 and the rear end member 52.

The side members 70 and 80 may extend along the periphery of the base plate 40 to define receiving spaces 31 in which the battery modules 10 are accommodated.

The plurality of battery modules 10 may be accommodated in the receiving spaces 31, respectively.

The receiving spaces 31 may be defined by a first connecting member 61, a second connecting member 62, a support member 63, a front member 64, a third connecting member 65, a fourth connecting member 66, and a rear member 67.

The first connecting member 61, the second connecting member 62, and the support member 63 may extend in the lengthwise direction of the battery housing 30 (in the X direction). In contrast, the front member 64, the third connecting member 65, the fourth connecting member 66, and the rear member 67 may extend in the left/right direction of the battery housing 30 (in the Y direction) to connect the first side member 70 and the second side member 80.

The front member 64 may be disposed adjacent to the front end member 51 and may support other modules for the battery pack system 1 that are disposed between the front member 64 and the front end member 51.

In contrast, the rear member 67 may be disposed adjacent to the rear end member 52 and may support other modules for the battery pack system 1 that are disposed between the rear member 67 and the rear end member 52.

The third connecting member 65 and the fourth connecting member 66 may be disposed between the front member 64 and the rear member 67. That is, the third connecting member 65 may be disposed between the front member 64 and the fourth connecting member 66, and the fourth connecting member 66 may be disposed between the third connecting member 65 and the rear member 67.

The first connecting member 61, the second connecting member 62, and the support member 63 may connect the other modules located at the front or rear of the battery housing 30 and the battery modules 10 to enable the battery modules 10 to be controlled by the other modules and may support the battery modules 10.

Likewise, the third connecting member 65 and the fourth connecting member 66 may support the battery modules 10 while connecting the battery modules 10 in the left/right direction (the Y direction).

Meanwhile, the electric vehicle may be vulnerable to fire. In particular, when a fire occurs in one battery module 10 accommodated in the battery housing 30, a thermal runaway phenomenon in which a fluid caused by the fire affects an adjacent battery module 10 in the battery housing 30 so that a plurality of battery cells continuously cause a fire may occur due to a structure in which a plurality of battery cells are arranged adjacent to one another in each of the battery modules 10.

To prevent the thermal runaway phenomenon, a component for guiding a high-temperature gas, which is a fluid generated due to the fire in the battery module 10, to the outside of the battery housing 30 may be required.

Hereinafter, the above-described structure will be described in detail.

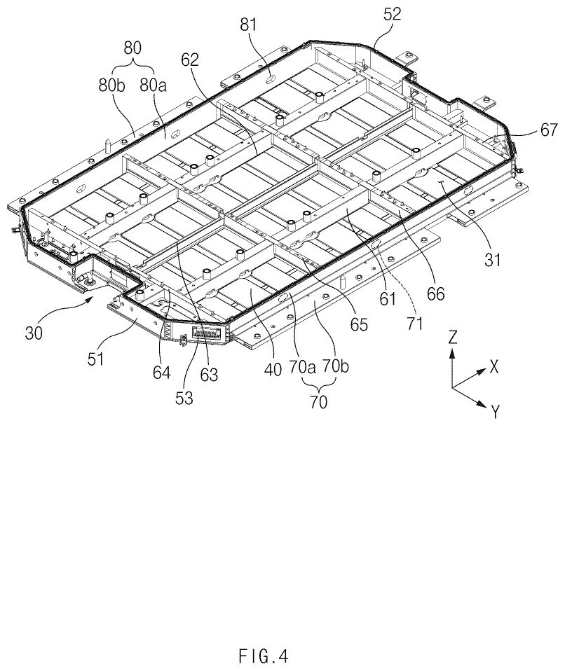

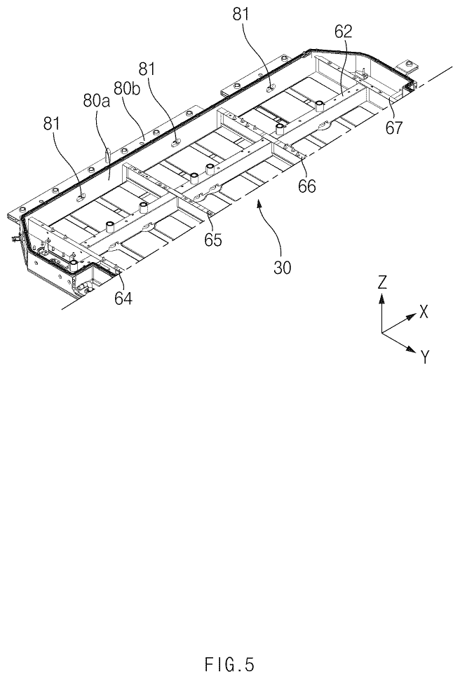

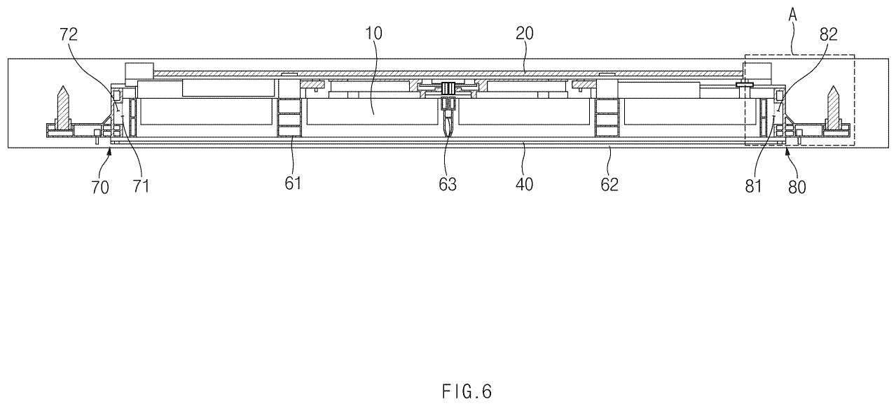

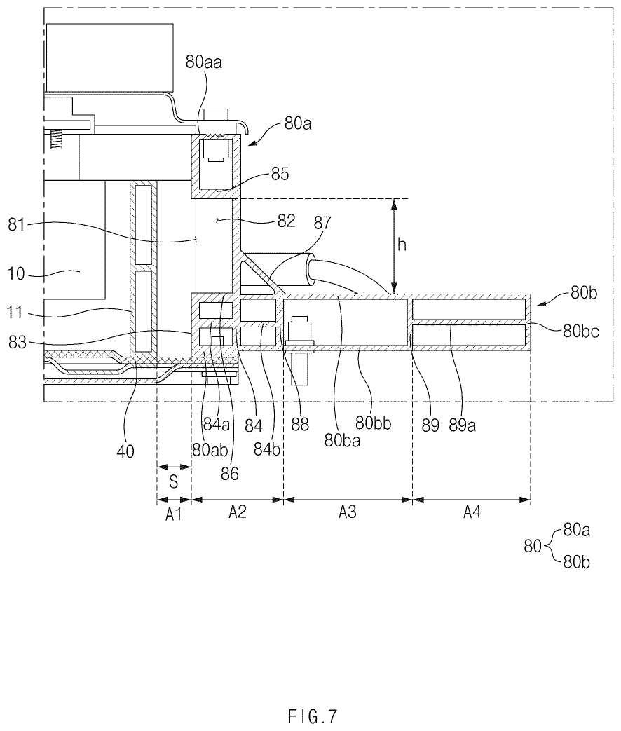

FIG. 4 is a perspective view of the battery housing 30 according to an embodiment of the present disclosure. FIG. 5 is a cutaway perspective view of the battery housing 30 illustrated in FIG. 4. FIG. 6 is a sectional view of the battery housing 30 according to an embodiment of the present disclosure. FIG. 7 is an enlarged view of portion A illustrated in FIG. 6.

Referring to FIGS. 4 to 7, the battery housing 30 according to an embodiment of the present disclosure may include guide passages 72 and 82 formed in the side members 70 and 80 to guide a fluid generated from the battery module 10 to the outside of the receiving spaces 31.

The guide passages 72 and 82 may be understood as components for releasing, to the outside of the battery housing 30, a high-temperature gas capable of causing heat transfer to an adjacent battery module 10 due to a fire occurring in the battery housing 30.

The guide passages 72 and 82 may extend in a first direction (the X direction) that is the lengthwise direction of the battery housing 30 and may guide the fluid generated from the battery module 10 in the lengthwise direction of the battery housing 30 (in the X direction).

In more detail, the first side member 70 may be disposed on the left side of the base plate 40 (in the Y direction), and the second side member 80 may be disposed on the right side of the base plate 40 (in the −Y direction). The first side member 70 and the second side member 80 may extend parallel to each other.

The first side member 70 may include a first cover part 70a extending toward the rear of the base plate 40 (in the X direction) to cover the battery modules 10 and a first support part 70b protruding from the first cover part 70a in the left direction (the Y direction) that is a direction toward the outside of the base plate 40.

The second side member 80 may include a second cover part 80a extending toward the rear of the base plate 40 (in the X direction) to cover the battery modules 10 and a second support part 80b protruding from the second cover part 80a in the right direction (the −Y direction) that is a direction toward the outside of the base plate 40.

The first cover part 70a and the second cover part 80a may extend to face each other. The first support part 70b and the second support part 80b may protrude from the first cover part 70a and the second cover part 80a in opposite directions, respectively. The first support part 70b and the second support part 80b may be fixedly coupled to a vehicle body frame of the electric vehicle.

The first cover part 70a may include the first guide passage 72 formed in the first cover part 70a and a first guide hole 71 that is connected to the first guide passage 72 and that introduces the fluid in the battery housing 30 into the first guide passage 72.

The second cover part 80a may include the second guide passage 82 formed in the second cover part 80a and a second guide hole 81 that is connected to the second guide passage 82 and that introduces the fluid in the battery housing 30 into the second guide passage 82.

The first guide hole 71 and the second guide hole 81 may be formed in the first cover part 70a and the second cover part 80a, respectively, and may be disposed to face each other.

According to an embodiment of the present disclosure, as compared with when a guide passage is formed in the first connecting member 61, the second connecting member 62, or the support member 63, there may be relatively few restrictions on the shape or number of guide holes 71 and 81.

The first connecting member 61, the second connecting member 62, or the support member 63 may extend in the lengthwise direction of the base plate 40 (in the X direction) to divide the receiving spaces 31 from one another in the left/right direction and may have to support the battery modules 10. The height of the first connecting member 61, the second connecting member 62, or the support member 63 may be set to be about 20 mm lower than that of the side members 70 and 80.

If a guide hole is formed in the first connecting member 61, the second connecting member 62, or the support member 63, the force with which the first connecting member 61, the second connecting member 62, or the supporting member 63 supports the battery modules 10 may be reduced so that the battery modules 10 may not be stably supported. In the case of the support member 63, the width in the left/right direction may be relatively narrow, and therefore there may be a limitation in forming the guide hole.

In contrast, according to the structure of the side members 70 and 80 according to an embodiment of the present disclosure, the guide holes 71 and 81 may be formed in the cover parts 70a and 80a of the side members 70 and 80, and the guide passages 72 and 82 connected with the guide holes 71 and 81 may be formed inside the cover parts 70a and 80a. Accordingly, the battery housing 30 according to an embodiment of the present disclosure may more stably support the battery modules 10. The sizes of the guide holes 71 and 81 may be made relatively large, and the numbers of guide holes 71 and 81 may also be increased. Thus, heat transfer between the battery modules 10 may be more effectively prevented.

The first side member 70 may be disposed on the left side of the battery modules 10 (in the Y direction), and the second side member 80 may be disposed on the right side of the battery modules 10 (in the −Y direction). The first side member 70 and the second side member 80 may be connected to the front end member 51 in the front direction (the −X direction). The first side member 70 and the second side member 80 may be connected to the rear end member 52 in the rear direction (the X direction).

In other words, the side members 70 and 80 may be disposed on the left and right sides of the battery modules 10 and may extend in the front/rear direction perpendicular to the left/right direction, and the end members 51 and 52 may be disposed on the opposite sides of the battery modules 10 in the front/rear direction and may be connected to the side members 70 and 80.

The end members 51 and 52 may form a discharge passage 51ba connected to the guide passages 72 and 82. The end members 51 and 52 may include the front end member 51 disposed on the front side of the side members 70 and 80 (in the −X direction) and the rear end member 52 disposed on the rear side of the side members 70 and 80 (in the X direction).

The front end member 51 may have a first opening/closing part 53 formed therein through which the high-temperature gas flowing through the first guide passage 72 is discharged to the outside of the battery housing 30.

Likewise, the rear end member 52 may have a second opening/closing part 54 formed therein through which the high-temperature gas flowing through the second guide passage 82 is discharged to the outside of the battery housing 30. The structures of the first opening/closing part 53 and the second opening/closing part 54 will be described below.

Hereinafter, only the second cover part 80a and the second support part 80b will be described. The structures of the first cover part 70a and the first support part 70b may correspond to the structures of the second cover part 80a and the second support part 80b, and the first cover part 70a and the first support part 70b may be disposed to be symmetrical to the second cover part 80a and the second support part 80b.

The second cover part 80a may include a guide wall 83 facing the battery modules 10 and a cover wall 84 that is spaced apart from the guide wall 83 and that defines the second guide passage 82 between the guide wall 83 and the cover wall 84.

The second guide hole 81 may be formed in the guide wall 83 and may introduce a high-temperature gas generated from the battery modules 10 into the second guide passage 82. Meanwhile, a plurality of second guide holes 81 may be provided along the battery modules 10 and may be spaced apart from each other. In other words, the plurality of second guide holes 81 may be provided in the lengthwise direction of the guide wall 83 (in the X direction) and may be spaced apart from each other.

For example, the battery modules 10 may be disposed in the receiving spaces 31 divided from one another by the first connecting member 61, the second connecting member 62, the support member 63, the front member 64, the third connecting member 65, the fourth connecting member 66, and the rear member 67.

Due to this structure, even when a fire occurs at any location in the battery module 10, a high-temperature gas generated by the fire may be guided to the outside of the battery housing 30, and thus heat transfer to the adjacent battery module 10 may be efficiently prevented.

As illustrated in FIG. 7, the second cover part 80a of the second side member 80 may include the guide wall 83 and the cover wall 84. The guide wall 83 and the cover wall 84 may extend parallel to each other in a direction perpendicular to the base plate 40.

The second cover part 80a may include an upper outer wall 80aa coupled with the upper cover 20 and a lower outer wall 80ab coupled with the base plate 40. The upper outer wall 80aa and the lower outer wall 80ab may extend parallel to each other.

The second cover part 80a may include an upper inner wall 85 disposed on the upper side of the second guide passage 82 and a lower inner wall 86 disposed on the lower side of the second guide passage 82. The upper inner wall 85 and the lower inner wall 86 may connect the guide wall 83 and the cover wall 84 and may be spaced apart from each other in the up/down direction to define the second guide passage 82 therebetween.

The vertical distance h between the upper inner wall 85 and the lower inner wall 86 may be about 40 mm. The vertical distance h between the upper inner wall 85 and the lower inner wall 86 may be a preferred length of the section of the guide hole 81 in the up/down direction under the constraint condition that the rigidity of the second cover part 80a is maintained.

The second cover part 80a may include a first horizontal inner wall 84a disposed between the lower inner wall 86 and the lower outer wall 80a . The upper inner wall 85, the lower inner wall 86, and the first horizontal inner wall 84a may improve the rigidity of the second cover part 80a.

Meanwhile, since the second cover part 80a and the second support part 80b extend in directions perpendicular to each other, the force with which the second cover part 80a and the second support part 80b support each other may be relatively weak. To solve this problem, the second side member 80 may include a support rib 87 that connects the second support part 80b and the second cover part 80a such that the second cover part 80a and the second support part 80b support each other. The second side member 80 may further include the support rib 87 extending from the second support part 80b to the second cover part 80a in an upward direction with respect to the direction toward the inside of the base plate 40.

In particular, the support rib 87 may extend toward the second guide passage 82 provided inside the second cover part 80a. The support rib 87 may include one end connected to the second support part 80b and an opposite end connected between the upper inner wall 85 and the lower inner wall 86.

According to this structure, the support rib 87 may improve the rigidity of the second cover part 80a and the second support part 80b by connecting the second cover part 80a and the second support part 80b. In more detail, in the structure in which the second guide passage 82 is provided, the support rib 87 may increase the rigidity of a portion of the second cover part 80a having a relatively low rigidity.

The second support part 80b may include a vertical outer wall 80bc that is disposed on the outermost side of the base plate 40 and that extends in the up/down direction, an upper support wall 80ba connecting an upper end of the vertical outer wall 80bc and the second cover part 80a, and a lower support wall 80bb connecting a lower end of the vertical outer wall 80bc and the second cover part 80a.

The upper support wall 80ba and the lower support wall 80bb may extend parallel to each other from the second cover part 80a toward the outside of the base plate 40. The vertical outer wall 80bc may connect the upper support wall 80ba and the lower support wall 80bb and may extend in the up/down direction.

The upper support wall 80ba may be connected to the support rib 87. In other words, the support rib 87 may obliquely extend from the upper support wall 80ba toward the cover wall 84. The lower support wall 80bb that is parallel to the upper support wall 80ba may be disposed under the upper support wall 80ba.

The second support part 80b may include vertical inner walls 88 and 89 disposed between the upper support wall 80ba and the lower support wall 80bb. The vertical inner walls 88 and 89 may include a first vertical inner wall 88 extending in the up/down direction between one end connected to the support rib 87 and an opposite end connected to the lower support wall 80bb and a second vertical inner wall 89 extending in the up/down direction between the first vertical inner wall 88 and the vertical outer wall 80bc. The first vertical inner wall 88 and the second vertical inner wall 89 may increase the rigidity of the second support part 80b.

The second support part 80b may include a first horizontal inner wall 84b that is located between the upper support wall 80ba and the lower support wall 80bb and that extends from the first vertical inner wall 88 to the cover wall 84.

The second support part 80b may include a second horizontal inner wall 89a that is located between the upper support wall 80ba and the lower support wall 80bb and that extends from the second vertical inner wall 89 to the vertical outer wall 80bc.

Since the second horizontal inner wall 89a is provided in a region A4 between the second vertical inner wall 89 and the vertical outer wall 80bc, the region A4 may have a higher rigidity than a region A3 between the first vertical inner wall 88 and the second vertical inner wall 89.

Due to this, the region A4 between the second vertical inner wall 89 and the vertical outer wall 80bc is a region for preventing bending against impact occurring on one side of the electric vehicle.

In contrast, the region A3 between the first vertical inner wall 88 and the second vertical inner wall 89 is a region for absorbing the impact occurring on the one side of the electric vehicle.

A region A2 between the first vertical inner wall 88 and the guide wall 83 may be understood as a region for preventing bending against the impact occurring on the one side of the electric vehicle due to the structure of the support ribs 87.

Meanwhile, the guide wall 83 may be spaced apart from the battery modules 10 in the left/right direction. In more detail, the guide wall 83 may be spaced apart from end plates 11 provided at opposite lateral ends of the battery modules 10.

The guide wall 83 may be spaced apart from the end plates 11 of the battery modules 10 by a separation distance S of about 15 mm. A region A1 between the guide wall 83 and the end plates 11 of the battery modules 10 may absorb the impact occurring on the one side of the electric vehicle due to the separation distance S between the guide wall 83 and the battery modules 10 and may prevent the impact from being transferred into the battery modules 10.

In addition, since the guide wall 83 is spaced apart from the battery modules 10, the high-temperature gas generated from the battery module 10 may be more smoothly introduced into the second guide passage 82, and the high-temperature gas in the battery housing 30 may be more smoothly discharged to the outside of the battery housing 30.

However, the embodiments of the present disclosure are not limited thereto, and it is sufficient to understand that the guide wall 83 and the battery modules 10 are spaced apart from each other.

The region A2 between the guide wall 83 and the first vertical inner wall 88 may be a region for preventing the cover part 80a and the support part 80b from being bent in response to the impact occurring on the one side of the electric vehicle due to the support rib 87.

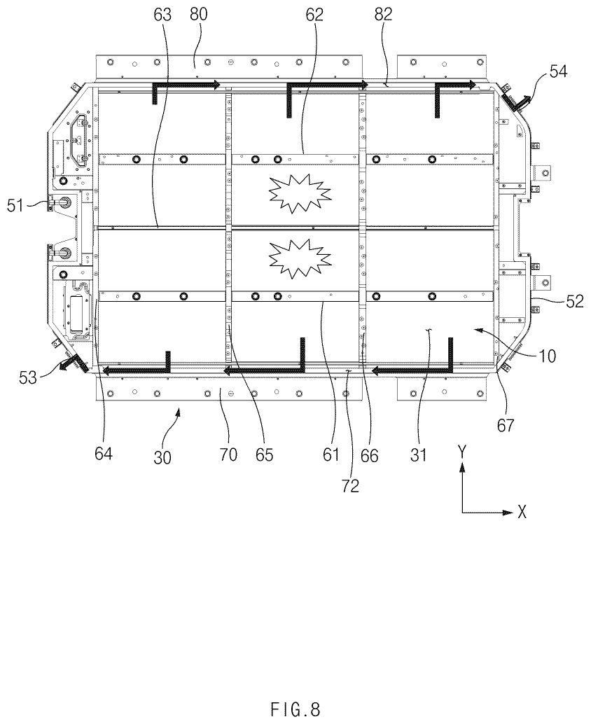

FIG. 8 is a schematic view illustrating a state in which a fluid generated from the battery module 10 is guided to the outside of the battery housing 30 according to an embodiment of the present disclosure.

Hereinafter, a principle by which a high-temperature gas caused by a fire occurring in the battery module 10 is discharged to the outside of the battery housing 30 will be described in detail with reference to FIG. 8.

When the fire occurs in the battery module 10, the high-temperature gas may be introduced into the guide passages 72 and 82 inside the side members 70 and 80, which are disposed on the opposite sides of the battery module 10, by the pressure caused by the fire.

The high-temperature gas caused by the fire occurring in the battery module 10 may be guided into the first guide passage 72 of the first side member 70 disposed on the left side of the battery module 10 (in the −Y direction) or the second guide passage 82 of the second side member 80 disposed on the right side of the battery module 10 (in the Y direction).

The high-temperature gas introduced into the guide passages 72 and 82 may be guided along the guide passages 72 and 82 in the lengthwise direction of the battery housing 30 (in the X direction).

In other words, the high-temperature gas introduced into the first guide passage 72 may be guided in the front direction (the −X direction) along the first guide passage 72 and may be discharged to the outside of the battery housing 30 through the first opening/closing part 53.

In addition, the high-temperature gas introduced into the second guide passage 82 may be guided in the rear direction (the X direction) along the second guide passage 82 and may be discharged to the outside of the battery housing 30 through the second opening/closing part 54.

However, unlike those illustrated in the drawing, the positions of the first opening/closing part 53 and the second opening/closing part 54 are not limited, and the first opening/closing part 53 and the second opening/closing part 54 may be located at places connected to the guide passages 72 and 82 such that the high-temperature gas flowing through the first guide passage 72 and the second guide passage 82 is discharged to the outside of the battery housing 30.

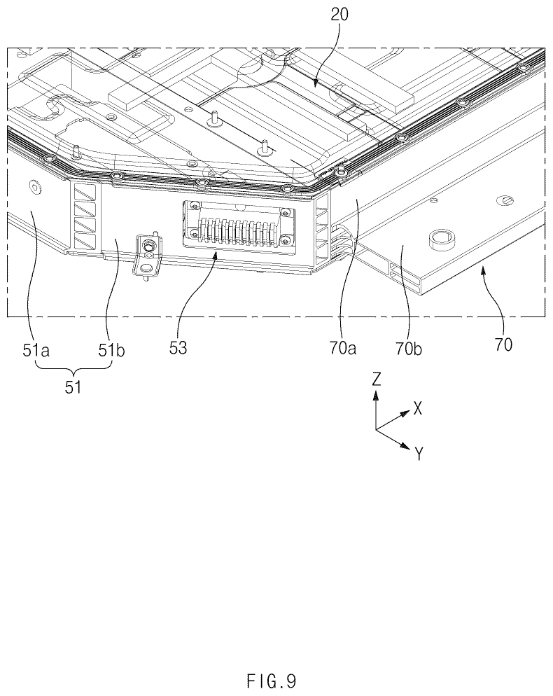

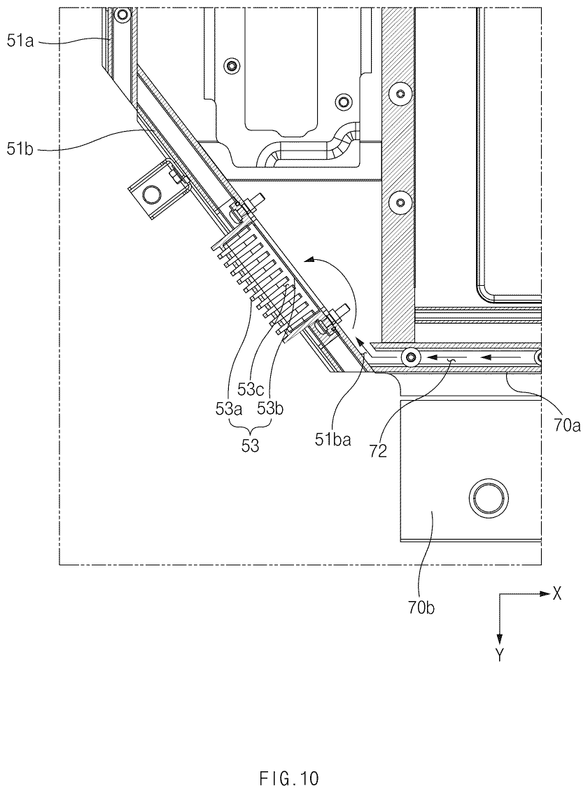

The first opening/closing part 53 will be described with reference to FIGS. 9 and 10. However, the structure of the second opening/closing part 54 may also be understood correspondingly.

FIG. 9 is an enlarged perspective view of the first opening/closing part 53 according to an embodiment of the present disclosure. FIG. 10 is a sectional view of the first opening/closing part 53 illustrated in FIG. 9.

Referring to FIGS. 9 and 10, the first opening/closing part 53 may be provided in a front part 51a facing in the front direction (the −X direction) or an inclined part 51b connecting the front part 51a and the first side member 70.

The inclined part 51b may extend from the first side member 70 toward the front part 51a. The first opening/closing part 53 may be provided in the inclined part 51b.

The first guide passage 72 that is provided inside the first cover part 70a and that extends in the front direction (the X direction) may be connected to the discharge passage 51ba formed by the front end member 51.

The first opening/closing part 53 may have a discharge hole 53c through which a fluid flowing through the discharge passage 51ba is discharged.

In more detail, the first opening/closing part 53 may include a cover grill 53a mounted in the inclined part 51b of the front end member 51 and a discharge plate 53b provided inward of the cover grill 53a.

The discharge plate 53b may be disposed inside the inclined part 51b and may be formed of aluminum (Al).

Before a fire occurs in the battery module 10, the discharge plate 53b may not form the discharge hole 53c. However, when a fire occurs in the battery module 10, the discharge plate 53b may be broken by the pressure of a high-temperature gas flowing through the first guide passage 72 to form the discharge hole 53c.

That is, as illustrated in FIG. 10, the high-temperature gas flowing through the first guide passage 72 may flow through the discharge passage 51ba, may break the discharge plate 53b, and may be discharged to the outside of the battery housing 30 while separating the cover grill 53a in the up/down direction.

Due to this structure, when a fire occurs in the battery module 10 inside the battery housing 30 according to an embodiment of the present disclosure, a high-temperature and high-pressure gas may be discharged to the outside of the battery housing 30 through the guide passages 72 and 82, and thus heat transfer between the battery modules 10 may be prevented. Accordingly, thermal runaway of the battery modules 10 may be relatively reduced.

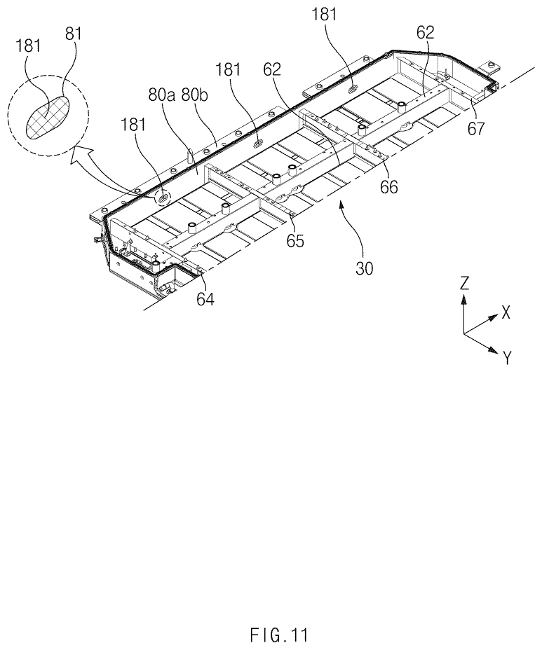

FIG. 11 is a cutaway perspective view of the battery housing 30 according to another embodiment of the present disclosure.

Referring to FIG. 11, mesh members 181 may be provided in the guide holes 71 and 81 formed in the side members 70 and 80 of the battery housing 30 illustrated in FIGS. 4 and 5.

The mesh members 181 may be provided in the guide holes 71 and 81 and may be formed in the guide walls 83 of the cover parts 70a and 80a. The mesh members 181 may cover the plurality of guide holes 71 and 81, respectively.

Due to the mesh members 181, even though a fire occurs in the battery module 10, only a high-temperature gas caused by the fire may be discharged to the outside of the battery housing 30 through the guide holes 71 and 81, and a flame or other particles may be prevented from being discharged to the outside of the battery housing 30.

That is, heat transfer between battery modules 10 may be prevented, and the flame may be prevented from being exposed outside the electric vehicle. Accordingly, the safety of the electric vehicle may be improved.

According to embodiments of the present disclosure, a fluid generated from one battery module may be guided to the outside of the battery housing. Accordingly, when a fire occurs in the battery module, heat may be prevented from being transferred to an adjacent battery module to prevent thermal runaway.

Furthermore, since the guide passages are formed in the side members of the battery housing, the shapes of the guide holes connected with the guide passages may be more freely formed, and thus productivity may be improved.

Moreover, since the mesh members are provided in the guide holes formed in the side members, a thermal conductive material or a flame may be prevented from being exposed outside the battery housing.

In addition, embodiments of the present disclosure may provide various effects that are directly or indirectly recognized.

Hereinabove, although embodiments of the present disclosure have been described with reference to exemplary embodiments and the accompanying drawings, the embodiments of the present disclosure are not limited thereto, but they may be variously modified and altered by those skilled in the art to which the present disclosure pertains without departing from the spirit and scope of the present disclosure claimed in the following claims.

Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

What is claimed is:

1. A battery housing comprising:
a base plate configured to support a battery module; and
a side member extending along a periphery of the base plate to define a receiving space in which the battery module is accommodated, wherein the side member has a guide passage defined therein to guide a fluid generated from the battery module to outside of the receiving space.

2. The battery housing of claim 1, wherein the side member comprises:
a guide wall facing the receiving space; and
a cover wall spaced apart from the guide wall to define the guide passage between the guide wall and the cover wall.

3. The battery housing of claim 2, wherein the guide wall comprises a guide hole connected to the guide passage.

4. The battery housing of claim 3, further comprising a mesh member disposed in the guide hole.

5. The battery housing of claim 2, wherein the guide wall comprises a plurality of guide holes, and wherein the guide holes are spaced apart from one another in a front/rear direction of the battery module.

6. The battery housing of claim 2, wherein the guide wall is spaced apart from the battery module in a first direction.

7. The battery housing of claim 1, wherein:
the side member is disposed on a first side of the battery module in a first direction and extends in a second direction perpendicular to the first direction; and
the battery housing further comprises an end member disposed on a second side of the battery module in the second direction and connected to the side member, the end member defining a discharge passage connected to the guide passage.

8. The battery housing of claim 7, further comprising an opening/closing part disposed in the end member to define a discharge hole through which the fluid flowing through the discharge passage is discharged.

9. The battery housing of claim 8, wherein the opening/closing part comprises:
a cover grill mounted in the end member; and
a discharge plate disposed inward of the cover grill and defining the discharge hole by pressure of the fluid flowing through the guide passage.

10. A battery housing comprising:
a base plate configured to support a battery module; and
a side member extending along a periphery of the base plate to define a receiving space in which the battery module is accommodated, wherein the side member comprises:
a guide passage defined therein to guide a fluid generated from the battery module to outside of the receiving space;
a cover part comprising a guide wall and a cover wall, wherein the guide wall faces the receiving space and the cover wall is spaced apart from the guide wall to define the guide passage between the guide wall and the cover wall;
a support part protruding from the cover part toward an outside of the base plate; and
a support rib extending from the support part to the cover part in an upward direction with respect to a direction toward an inside of the base plate.

11. The battery housing of claim 10, wherein the cover part comprises:
an upper inner wall connecting the guide wall and the cover wall and disposed on an upper side of the guide passage; and
a lower inner wall spaced downward from the upper inner wall and disposed on a lower side of the guide passage.

12. The battery housing of claim 11, wherein a first end of the support rib is connected to the support part and a second end of the support rib, opposite the first end, is connected between the upper inner wall and the lower inner wall.

13. The battery housing of claim 10, wherein the support part comprises:
an upper support wall connected to the support rib;
a lower support wall disposed under the upper support wall; and
a first vertical inner wall extending in an up/down direction between a first end connected to the support rib and a second, opposite end connected to the lower support wall.

14. The battery housing of claim 13, wherein the support part further comprises:
a vertical outer wall connecting the upper support wall and the lower support wall; and
a second vertical inner wall disposed between the first vertical inner wall and the vertical outer wall and extending in the up/down direction between the upper support wall and the lower support wall.

15. The battery housing of claim 14, wherein the support part further comprises:
a first horizontal inner wall connecting the first vertical inner wall and the cover wall; and
a second horizontal inner wall connecting the second vertical inner wall and the vertical outer wall.

16. A battery pack system comprising:
a battery module;
an upper cover covering an upper surface of the battery module; and
a battery housing covering a lower surface and lateral surfaces of the battery module, the battery housing comprising:
a base plate covering the lower surface of the battery module and configured to support the battery module; and
a front end member disposed at a front of the base plate;
a rear end member disposed at a rear of the base plate; and
side members disposed on opposite sides of the base plate and extending along a periphery of opposite sides of the base plate to define a receiving space in which the battery module is accommodated, wherein each of the side members has a guide passage defined therein to guide a fluid generated from the battery module to outside of the receiving space.

17. The battery pack system of claim 16, wherein each of the side members comprises:
a guide wall facing the receiving space; and
a cover wall spaced apart from the guide wall to define the guide passage between the guide wall and the cover wall.

18. The battery pack system of claim 17, wherein the guide wall comprises a guide hole connected to the guide passage.

19. The battery pack system of claim 18, further comprising a mesh member disposed in the guide hole.

20. The battery pack system of claim 17, wherein the guide wall comprises a plurality of guide holes, and wherein the guide holes are spaced apart from one another in a front/rear direction of the battery module.
